(19) United States
(12) Patent Application Publication
(10) Pub. No.: US 2024/0391736 A1
(43) Pub. Date: Nov. 28, 2024

(54) ELEVATOR SUSPENSION MEMBER MONITORING SYSTEM

(71) Applicant: OTIS ELEVATOR COMPANY, Farmington, CT (US)

(72) Inventor: Kyle P. Connolly, NEWINGTON, CT (US)

(21) Appl. No.: 18/202,510

(22) Filed: May 26, 2023

(51) Int. Cl. B66B 7/12; B66B 9/00

(52) U.S. Cl. CPC B66B 7/1215; B66B 9/00

(57) ABSTRACT

A method and apparatus are provided for monitoring a suspension member that supports an elevator car and experiences bend cycles as the suspension member facilitates movement of the elevator car between a plurality of door zones. The method and apparatus determine: a number of times the elevator car passes or stops at each of the plurality of door zones; a number of bend cycles experienced by at least one section of the suspension member based on the number of times the elevator car passes or stops at each of the plurality of door zones; and a condition of the suspension member based on a relationship between a determined number of bend cycles and at least one predetermined criterion.

### BACKGROUND

Elevator systems are in widespread use for carrying passengers between various levels in buildings, for example. Some elevator systems are traction-based in which a suspension assembly, suspends the elevator car and a counterweight. The suspension assembly also facilitates movement of the elevator car between building floors. Traditional suspension members comprise ropes or belts.

The suspension members are monitored for service life purposes. In one example, suspension member condition can be determined using cycle-counting based on each time the elevator starts. In another example, a device monitors when a belt section passes over sheaves on which the suspension member is supported. These traditional methods can result in the premature retirement of suspension members in the field. For example, every run counts as a cycle if direction cannot be proven. However, the entire belt is not subject to the bends, meaning parts of the belt that were not strained are now being counted as such, and retired early. This increases service and material costs.

### SUMMARY

An illustrative example method comprises monitoring a suspension member that supports an elevator car and experiences bend cycles as the suspension member facilitates movement of the elevator car between a plurality of door zones, the method further comprising:
determining a number of times the elevator car passes or stops at each of the plurality of door zones;
determining a number of bend cycles experienced by at least one section of the suspension member based on the number of times the elevator car passes or stops at each of the plurality of door zones; and
determining a condition of the suspension member based on a relationship between a determined number of bend cycles and at least one predetermined criterion.

In addition to one or more of the features described above, or as an alternative, determining the number of bend cycles experienced by the at least one section of the suspension member comprises determining a respective number of bend cycles for each of a plurality of sections of the suspension member; and the determined number of bend cycles for each of the sections is independent of other sections at other door zones.

In addition to one or more of the features described above, or as an alternative, the predetermined criteria comprises a predetermined number of bend cycles and the method includes: determining a condition of the suspension member based on the counted number of bend cycles for each section of the suspension member, and determining to remove the suspension member from service when one of the counted number of bend cycles for the associated door zone exceeds the predetermined number of bend cycles.

In addition to one or more of the features described above, or as an alternative, the method includes providing the elevator car with a first sensor and each door zone with a second sensor, wherein the first and second sensors cooperate with each other to determine when the elevator car is passing through each door zone such that an associated counter for that door zone is increased by one.

In addition to one or more of the features described above, or as an alternative, one of the first and second sensors comprises a transmitting device and the other of the first and second sensors comprises a receiving device.

In addition to one or more of the features described above, or as an alternative, the suspension member comprises a belt that connects the elevator car to a counterweight.

In addition to one or more of the features described above, or as an alternative, the method includes moving the belt around one or more sheaves as the elevator moves between the door zones, and wherein one bend cycle for the at least one section occurs as the at least one section moves around one of the sheaves.

An illustrative example embodiment of an elevator system includes: an elevator car; a suspension member that supports the elevator car and experiences bend cycles as the suspension member facilitates movement of the elevator car between a plurality of door zones; and a counter located at each door zone, wherein each counter is configured to provide an indication of a number of times the elevator car is situated at or passes through an associated door zone for that counter, wherein the indication of each counter corresponds to a number of bend cycles experienced by at least one section of the suspension member.

In addition to one or more of the features described above, or as an alternative, each counter indication increases by one as the elevator car passes through the associated door zone for that counter; the increased counter indication corresponds to a number of bends that some sections of the suspension member experiences; and each section has a counted number of bend cycles that is independent of other sections.

In addition to one or more of the features described above, or as an alternative, the predetermined criteria comprises a predetermined number of bend cycles and including at least one processor configured to:
determine a condition of the suspension member based on the counted number of bend cycles for at least one section of the suspension member, and
determine to remove the suspension member from service when at least one of the counted number of bend cycles exceeds the predetermined number of bend cycles.

In addition to one or more of the features described above, or as an alternative, the elevator car includes a first sensor and each door zone includes a second sensor, wherein the first and second sensors cooperate with each other to determine when the elevator car is passing through each door zone such that an associated counter indication for that door zone is increased by one.

In addition to one or more of the features described above, or as an alternative, one of the first and second sensors comprises a transmitting device and the other of the first and second sensors comprises a receiving device.

In addition to one or more of the features described above, or as an alternative, the suspension member comprises a belt that connects the elevator car to a counterweight.

In addition to one or more of the features described above, or as an alternative, the belt moves around one or more sheaves as the elevator moves between door zones, and wherein one bend cycle for a section occurs as the section moves around one of the sheaves.

In addition to one or more of the features described above, or as an alternative, a total counter number corresponding to a maximum of all of the counter indications differs from a total number of bend cycles for at least some sections of the suspension member.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system according to an embodiment;

FIG. 2 schematically illustrates the elevator system of FIG. 1 with counters at each door zone and with an elevator car starting at a first level door zone;

FIG. 3 schematically illustrates the elevator system of FIG. 2 with the elevator car moving from the first level door zone to a third level door zone;

FIG. 4 schematically illustrates the elevator system of FIG. 2 with the elevator car moving from the third level door zone to a second level door zone; and

FIG. 5 schematically illustrates the elevator system of FIG. 2 with the elevator car moving from the second level door zone to a fourth level door zone.

### DETAILED DESCRIPTION

Embodiments of this disclosure provide enhanced monitoring of an elevator suspension member, such as a belt for example. The disclosed method and system improves the accuracy of how many bends the belt actually experiences as compared to traditional methods. The subject method gives a more accurate assessment of which belt section is being most stressed, which in turn gives a better idea of an overall condition of the belt. This will allow belts to remain longer in their current applications. As a result, the expense, time, and inconvenience associated with prematurely removing a suspension member from service before it is actually necessary can be avoided.

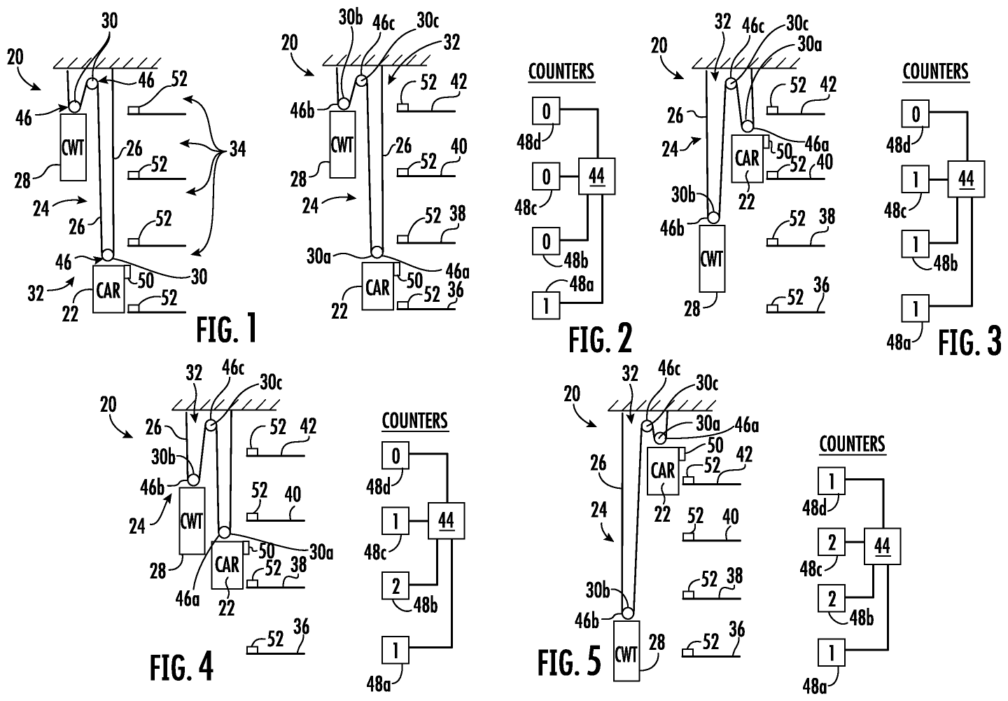

FIG. 1 schematically illustrates selected portions of an elevator system 20. An elevator car 22 is supported by a suspension assembly 24 that includes at least one suspension member 26. The elevator car 22 is coupled to a counterweight 28 by the suspension member 26. The suspension member 26 follows a path established by a plurality of sheaves 30. In one example, one sheave 30a (FIG. 2) is associated with the elevator car 22, one sheave 30b is associated with the counterweight 28, and one sheave 30c is at fixed location near a top of an elevator shaft 32. Other embodiments include different sheave configurations with a different number of sheaves or a different roping ratio.

The elevator car 22 is configured to move between a plurality of landings or door zones 34. The elevator car 22 moves vertically (up and down) between the plurality of landings or door zones 34. In the example shown in FIGS. 2-5, the elevator car 22 is initially positioned at a first level door zone 36, e.g. a lobby. The elevator car 22 can be selectively called to a second level door zone 38, a third level door zone 40, or a fourth level door zone 42. In this description, the designations of the first through fourth level door zones do not necessarily correspond to a building level or floor, but, instead are used for discussion purposes. Some embodiments include more door zones along the hoistway. It is contemplated that the elevator car 22 is configured to move laterally between elevator zones or elevator bays.

A suspension member monitoring device includes at least one processor 44 that is configured to determine a condition of the suspension member 26. The processor 44 in the illustrated example includes a computing device and associated memory. The processor 44 is programmed or otherwise configured to receive data and/or other information indicative of a respective condition of the suspension member 26 to determine when it is desirable or necessary to remove the suspension member 26 from service.

As the elevator car 22 moves between the different door zones 34, sections of the suspension member 26 wrap or bend around the sheaves 30. In one example, a belt section is defined as the length of belt between two door zones. Each contact interface between the suspension member 26 and the sheave 30 comprises a bend 46 such that each time a respective section of the suspension member 26 travels around an associated sheave 30 it comprises one bend cycle. As known by those skilled in the art, bend cycles are associated with an amount of bending of the suspension member 26 as it moves around a sheave 30. In the example shown in FIG. 2, there are three bends 46, e.g. a first bend 46a at the sheave 30a associated with the elevator car 22, a second bend 46b at the sheave 30b associated with the counterweight 28, and a third bend 46c at the sheave 30c related to the elevator machine and that is at fixed location near the top of the elevator shaft 32.

In order to determine which section of the suspension member 26 is the most stressed, a counting device 48a-d is positioned at each door zone 34. In the example shown in FIGS. 2-5, a first counter 48a is located at the first level door zone 36, a second counter 48b is located at the second level door zone 38, a third counter 48c is located at the third level door zone 40, and a fourth counter 48d is located at the fourth level door zone 42.

The processor 44 receives the counting information for each door zone 36, 38, 40, 42 for evaluation. The processor 44 utilizes this information to determine and monitor the status or condition of the suspension member 26.

In one example, each counter 48 is increased by one bend cycle as the elevator car 22 passes through an associated door zone 36, 38, 40, 42 for that counter 48a, 48b, 48c, 48d. The processor 44 then compares the bend cycles counted for each door zone 36, 38, 40, 42 to a predetermined criteria. Increasing each counter 48a-d by one as the elevator car 22 passes through the associated door zone 36, 38, 40, 42 for that counter 48a, 48b, 48c, or 48d translates directly to a number of bends that each section of the suspension member 26 experiences such that each section at the associated door zone 36, 38, 40, or 42 has a counted number of bend cycles that is independent of other sections of the suspension member 26 at other door zones 36, 38, 40, or 42.

The processor 44 is configured, such as by programming, to use a predetermined relationship between the features of the elevator system and the counter locations to translate the count information to the number of bends experienced by various sections of the suspension member 26. For example, the number and placement of the sheaves 30, the roping ratio, and the type of the suspension assembly 24 are factors that establish the relationship between the bend cycles experienced by a section or portion of the suspension member 26 and the position of the elevator car 22. Comparing FIGS. 2 and 3, for example, reveals that different sections or portions of the suspension member 26 are wrapped around a sheave, depending on the position of the elevator car 22. Those skilled in the art who have the benefit of this description will be able to determine how individual count values correspond to the number of bend cycles experienced by different suspension member sections based on a particular elevator system configuration.

In one example, the predetermined criteria comprise a predetermined number of bend cycles. The predetermined number of bend cycles can be determined based on different criteria such as the type of suspension member 26, the material of the suspension member 26, the number of bends 46, the type of elevator application, etc. In one example, the predetermined number of bend cycles comprises a look-up table that is stored in the memory of the processor 44. The processor 44 is configured to determine a condition of the suspension member 26 based on the counted number of bend cycles for each section of the suspension member 26. The processor 44 is also configured to determine that the suspension member 26 should be removed from service when one of the counted number of bend cycles for the associated door zone 36, 38, 40, or 42 exceeds the predetermined number of bend cycles.

In one example, the elevator car 22 is provided with a first sensor 50 and each door zone 36, 38, 40, 42 is provided with a second sensor 52. The first 50 and second 52 sensors cooperate with each other to determine when the elevator car 22 is passing through each door zone 36, 38, 40, 42 such that an associated counter 48a-d for that door zone is increased by one. These sensors can comprise existing sensors that are used to recognize door locations when taking passengers to their desired floor level. In one example, one of the first 50 and second 52 sensors comprises a transmitting device and the other of the first 50 and second 52 sensors comprises a receiving device; however, other types of sensors could also be used.

A progression through FIGS. 2-5 shows one example of how the subject counting method operates. FIG. 2 shows the elevator car starting at an initial position at the first level door zone 36, e.g. the lobby. In this position, the first floor counter 48a shows a count of “1” and the remaining counters 48b-c are at zero.

FIG. 3 shows the elevator car 22 moving from the first level door zone 36 to the third level door zone 40. In this position, the first floor counter 48a remains a count of “1”, the second floor counter 48b increases to a count of “1”, the third floor counter 48c increases to a count of “1”, and the fourth floor counter count remains at zero because the elevator car 22 has not yet reached the door zone 42.

FIG. 4 shows the elevator car 22 moving from the third level door zone 40 to a second level door zone 38. As a result of such movement to this position, the first floor counter 48a remains at a count of “1”, the second floor counter 48b increases to a count of “2”, the third floor counter 48c remains at a count of “1”, and the fourth floor counter remains at a count of zero.

FIG. 5 shows the elevator car 22 moving from the second level door zone 38 to the fourth level door zone 42. As a result of moving this position, the first floor counter 48a remains at a count of “1”, the second floor counter 48b remains at a count of “2”, the third floor counter 48c is now at a count of “2”, and the fourth floor counter is now at a count of “1”. In a traditional cycle counting method, as the elevator car 22 has moved between the positions shown in FIGS. 2-5, the bend cycle count could already be as high as “4”, which corresponds to four runs of the elevator car or the elevator car answering four calls, for example. Such movement of the elevator car 22 does not require the entire suspension member 26 to experience four bend cycles. As can be appreciated from the drawings, actually no section of the suspension member 26 has experienced more than two bend cycles.

The subject method and apparatus determines and monitors a condition of a suspension member 26 by adding a counter at selected door zones 36, 38, 40, 42 along a hoistway 32. When the elevator car 22 passes through each door zone 36, 38, 40, 42, the corresponding counter goes up by one. This translates directly to the number of bends 46 that each section of the suspension member 26 experiences, since the bends 46 are always at the same known location on the suspension member 26 at each floor. This will give an accurate assessment of how many times each section of the suspension member 26 bends around a sheave 30, rather than assuming the whole suspension member 26 experienced the bend each time the elevator car 22 moves. The processor 44 receives information regarding the location of the elevator car 22 from existing sensors or determines the elevator car location using a known technique. As such, only a counting device 48 need be added at the selected door zones such that the respective counts can be stored in the processor 44. The processor 44 then references the individual counts against a criterion for how many bends individual sections of the suspension member 26 experience before suspension member retirement.

The disclosed example embodiment and others like it provide an improvement over a traditional cycle counting for suspension members 26, as the determined number of bends for individual sections of the suspension member 26 is an actual number, rather than simply relying on number of runs and counting each run as a bend cycle for the entire suspension member 26. This method gives a more accurate assessment of which section is the most stressed over time, which gives a better indication of the condition of the suspension member 26. As a result, the expense, time and inconvenience associated with prematurely removing a suspension member from service before it is actually necessary can be avoided.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

What is claimed is:

1. A method of monitoring a suspension member that supports an elevator car and experiences bend cycles as the suspension member facilitates movement of the elevator car between a plurality of door zones, the method comprising:
determining a number of times the elevator car passes or stops at each of the plurality of door zones;
determining a number of bend cycles experienced by at least one section of the suspension member based on the number of times the elevator car passes or stops at each of the plurality of door zones; and
determining a condition of the suspension member based on a relationship between a determined number of bend cycles and at least one predetermined criterion.

2. The method of claim 1, wherein determining the number of bend cycles experienced by the at least one section of the suspension member comprises
determining a respective number of bend cycles for each of a plurality of sections of the suspension member; and
the determined number of bend cycles for each of the sections is independent of other sections at other door zones.

3. The method of claim 2, wherein the at least one predetermined criteria comprises a predetermined number of bend cycles and including:
determining a condition of the suspension member based on the counted number of bend cycles for each section of the suspension member, and
determining to remove the suspension member from service when one of the counted number of bend cycles for the associated door zone exceeds the predetermined number of bend cycles.

4. The method of claim 3, including providing the elevator car with a first sensor and each door zone with a second sensor, wherein the first and second sensors cooperate with each other to determine when the elevator car is passing through each door zone such that an associated counter for that door zone is increased by one.

5. The method of claim 4, wherein one of the first and second sensors comprises a transmitting device and the other of the first and second sensors comprises a receiving device.

6. The method of claim 1, wherein the suspension member comprises a belt that connects the elevator car to a counterweight.

7. The method of claim 6, including moving the belt around one or more sheaves as the elevator car moves between the door zones, and wherein one bend cycle for the at least one section occurs as the at least one section moves around one of the sheaves.

8. An elevator system, comprising:
an elevator car;
a suspension member that supports the elevator car and experiences bend cycles as the suspension member facilitates movement of the elevator car between a plurality of door zones; and
a counter located at each door zone, wherein each counter is configured to provide an indication of a number of times the elevator car is situated at or passes through an associated door zone for that counter, wherein the indication of each counter corresponds to a number of bend cycles experienced by at least one section of the suspension member.

9. The elevator system of claim 8, wherein each counter indication increases by one as the elevator car passes through the associated door zone for that counter;
the increased counter indication corresponds to a number of bends that some sections of the suspension member experiences; and
each section has a counted number of bend cycles that is independent of other sections.

10. The elevator system of claim 9, further comprising at least one processor configured to identify a predetermined number of bend cycles, and configured to predetermine a criteria including:
determine a condition of the suspension member based on the counted number of bend cycles for at least one section of the suspension member, and
determine to remove the suspension member from service when at least one of the counted number of bend cycles exceeds the predetermined number of bend cycles.

11. The elevator system of claim 10, wherein the elevator car includes a first sensor and each door zone includes a second sensor, wherein the first and second sensors cooperate with each other to determine when the elevator car is passing through each door zone such that an associated counter indication for that door zone is increased by one.

12. The elevator system of claim 11, wherein one of the first and second sensors comprises a transmitting device and the other of the first and second sensors comprises a receiving device.

13. The elevator system of claim 8, wherein a total counter number corresponding to a maximum of all of the counter indications differs from a total number of bend cycles for at least some sections of the suspension member.

14. An elevator system, comprising:
an elevator car;
a suspension member that supports the elevator car and experiences bend cycles as the suspension member facilitates movement of the elevator car between a plurality of door zones, the suspension member comprising a belt that connects the elevator car to a counterweight; and
a counter located at each door zone, wherein each counter is configured to provide an indication of a number of times the elevator car is situated at or passes through an associated door zone for that counter, wherein the indication of each counter corresponds to a number of bend cycles experienced by at least one section of the suspension member.

15. The elevator system of claim 14, wherein the belt moves around one or more sheaves as the elevator car moves between door zones, and wherein one bend cycle for a section occurs as the section moves around one of the sheaves.

16. The elevator system of claim 14, wherein each counter indication increases by one as the elevator car passes through the associated door zone for that counter;
the increased counter indication corresponds to a number of bends that some sections of the suspension member experiences; and
each section has a counted number of bend cycles that is independent of other sections.

17. The elevator system of claim 15, further comprising at least one processor configured to identify a predetermined number of bend cycles, and configured to predetermine a criteria including at least one of:
determine a condition of the suspension member based on the counted number of bend cycles for at least one section of the suspension member, and
determine to remove the suspension member from service when at least one of the counted number of bend cycles exceeds the predetermined number of bend cycles.

18. The elevator system of claim 14, wherein the elevator car includes a first sensor and each door zone includes a second sensor, wherein the first and second sensors cooperate with each other to determine when the elevator car is passing through each door zone such that an associated counter indication for that door zone is increased by one.

19. The elevator system of claim 18, wherein one of the first and second sensors comprises a transmitting device and the other of the first and second sensors comprises a receiving device.

20. The elevator system of claim 14, wherein a total counter number corresponding to a maximum of all of the counter indications differs from a total number of bend cycles for at least some sections of the suspension member.
